(19) United States
(12) Patent Application Publication
(10) Pub. No.: US 2006/0005067 A1
(43) Pub. Date: Jan. 5, 2006

(54) Systems, devices, and methods for generating and processing application test data

(76) Inventor: Dennis Llyod JR., Malvern, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/158,475

(22) Filed: Jun. 22, 2005

Related U.S. Application Data
(60) Provisional application No. 60/584,628, filed on Jul. 1, 2004.

(51) Int. Cl. G06F 11/00

(52) U.S. Cl. 714/4

(57) ABSTRACT

Certain exemplary embodiments comprise a data generator system and method that comprises generating an executable procedure from a template comprising a structure. The system and method comprises processing the executable procedure to generate a plurality of data items. The system and method comprises automatically outputting the plurality of data items in a desired data format.

### CROSS-REFERENCES TO RELATED APPLICATIONS

This application claims priority to pending U.S. Provisional Patent Application Ser. No. 60/584,628 (Attorney Docket No. 2004P11097US01 (1009-116)), filed Jul. 01, 2004.

### BACKGROUND

Data is managed by software applications in a variety of ways such as moved between components within an application, stored by the application, read by the application, and shared between two or more applications, etc. Data managed by software applications is specified in a wide variety formats. Data is also stored and transmitted by a number of means. For example, data is stored in XML format in a text file. As another example, data is stored in a proprietary format in a database. Some data formats have complex structures or a wide range of possible values.

Software applications need to be thoroughly tested to ensure proper performance. Regardless of the approach to testing, data is fed to the application. It is often desirable to provide both valid and invalid data to the application for performance testing.

A common approach to creating data for testing applications is to use existing client data. There are several potential problems with this approach. First, the confidentiality of client data (particularly in the case of patient medical data, for example) is at risk when it is used in this way. The more often that confidential data is copied between systems, stored on testing machines, and loaded into development databases, the higher the risk for an un-trusted and/or malicious person to have access to the data. Second, client data does not necessarily model invalid cases, cases that are present under certain conditions, cases that result from functionality not present in client data, or uncommon cases that simply have not occurred in the client data. Using client data often limits the number of test cases that may be developed and therefore limits the quality of testing conducted. Third, client data is not always available. For applications in new markets, applications that use data that hasn't yet been collected, or for clients that are not willing to release their data for software development, finding data to use for testing may be difficult.

One of the common alternatives to using client data is to either create the data manually or modify client data to model specific cases. However, data structures and ranges of values to be tested typically make manually creating test values prohibitively expensive. The amount of data used for testing causes users to spend time typing test data. When the data structures are large (for complex structures) or the number of data items is large (for performance testing or benchmarking), too much time is often spent configuring the data. In addition, data structures may be difficult to navigate to locate an appropriate place to edit. Data structures sometimes comprise complex XML structures, HL7 structures, binary data, and/or hexadecimal data, etc. Moreover, even modified client data suffers from the problem that confidentiality might be compromised.

Using client data or using data created manually also presents another possible problem. A software application is programmed to behave differently based on data provided. Software application behavior is often contingent on variations of small pieces of data within a much larger data structure. Thus, testing often revolves around small parts of a data set at a given point in time. It is possible to get lost within a large data set trying to find just one value that might be different. This impairs a user's ability to track which data set is used for a given test and the purpose of the test. Exemplary systems address these deficiencies and related problems.

### SUMMARY

Certain exemplary embodiments comprise a data generator system and method that comprises generating an executable procedure from a template comprising a structure. The system and method comprises processing the executable procedure to generate a plurality of data items. The system and method comprises automatically outputting the plurality of data items in a desired data format.

### BRIEF DESCRIPTION OF THE DRAWINGS

A wide variety of potential embodiments are more readily understood through the following detailed description, with reference to the accompanying exemplary drawings in which:

FIG. 1 is a block diagram of an exemplary embodiment of a system 1000 for processing application test data;

FIG. 2 is a flowchart of an exemplary embodiment of a method for processing application test data 2000;

FIG. 3 is a block diagram of an exemplary embodiment of an information device 3000;

FIG. 4 is an exemplary embodiment of a class diagram 4000 of a Data Generator;

FIG. 5 is an exemplary embodiment of a class diagram 5000 of a Data Generator;

FIG. 6A is an exemplary embodiment of a first section of a template;

FIG. 6B is an exemplary embodiment of a second section of a template;

FIG. 7 is an exemplary embodiment of a test case model;

FIG. 8A is an exemplary embodiment of a first section of an implementation in Java;

FIG. 8B is an exemplary embodiment of a second section of an implementation in Java;

FIG. 8C is an exemplary embodiment of a third section of an implementation in Java; and

FIG. 8D is an exemplary embodiment of a fourth section of an implementation in Java.

### DEFINITIONS

When the following terms are used herein, the accompanying definitions apply:
a—at least one.
activity—an action, act, step, and/or process or portion thereof.
ASCII—a standard for assigning numerical values to the set of letters in the Roman alphabet and typographic characters.
automatically—acting or operating in a manner essentially independent of external influence or control.
adapted to—made suitable or fit for a specific use or situation.
apparatus—an appliance or device for a particular purpose.
code—a system of symbols and rules adapted to represent instructions to an information device.
command—a signal that initiates an operation defined by an instruction.
comprising—including but not limited to.
creatable—adaptable to generate.
CSV—a database import/export format and file extension associated with comma separated values.
data—distinct pieces of information, usually formatted in a special or predetermined way and/or organized to express concepts.
database—a structured collection of data. A database comprises a group of records, each record containing related data that are stored in pre-defined fields.
data formatter—hardware and/or software adapted to automatically output data in a predetermined format.
data format—a predetermined arrangement of information for storage and/or display.
data generation—an act and/or process adapted to create data.
data generator—hardware and/or software adapted to create data.
data reader—hardware and/or software adapted to obtain information from a memory device.
define—to establish the outline, form, or structure of.
desired—requested.
display generator—a known element comprising electronic circuitry or software or a combination of both for generating display images or portions thereof.
determine—ascertain, obtain, and/or calculate.
exchanging—providing and receiving in a reciprocal interchange.
executable procedure—a segment of code (machine readable instruction), subroutine, or other distinct section of code or portion of an executable application for performing one or more particular processes and may include performing operations on received input parameters (or in response to received input parameters) and provide resulting output parameters.
execution—a process of carrying out machine-readable instructions on by an information device.
file—a set of data, such as related data, that is kept together.
generate—an act or process adapted to produce a result.
hierarchically ordered—organized according to a ranked structure.
HL7—Health Level 7, the ANSI standard for information interchange between foreign systems in the healthcare industry. The “7” refers to the fact that the protocol is designed to address the 7th layer of the International Standards Organization's Open System Interconnect model (the application layer).
HTML—a markup language used to structure text and multimedia documents and to set up hypertext links between documents, used extensively on the World Wide Web.
individual—a distinct entity.
information device—any processing device (in software or hardware) capable of processing information, such as any general purpose and/or special purpose computer, such as a personal computer, workstation, server, minicomputer, mainframe, supercomputer, computer terminal, laptop, wearable computer, and/or Personal Digital Assistant (PDA), etc.
initiating—beginning.
input/output (I/O) device—any sensory-oriented input and/or output device, such as an audio, visual, haptic, olfactory, and/or taste-oriented device, potentially including a port to which an I/O device is attached or connected.
instructions—directions adapted to perform a particular operation or function.
invalid case—a value and/or state not allowed according to a predefined rule.
item—a single article of a plurality of articles.
iteratively—repetitively.
Machine-readable medium—a physical structure from which a machine obtains data and/or information. Examples include a memory, punch cards, etc.
may—is allowed to, in at least some embodiments.
medical—of or relating to the study or practice of medicine.
memory device—an apparatus capable of storing analog or digital information, such as instructions and/or data.
method—a process, procedure, and/or collection of related activities for accomplishing something.
mutually interact—act in concert with another entity.
network—a communicatively coupled plurality of nodes.
network interface—any device, system, or subsystem capable of coupling an information device to a network. Exemplary network interfaces comprise a telephone, cellular phone, cellular modem, telephone data modem, fax modem, wireless transceiver, ethernet card, cable modem, digital subscriber line interface, bridge, hub, router, or other similar device.
obtain—to receive or determine.
output—data produced by an information device executing machine-readable instructions.
particular—specific.
plurality—the state of being plural and/or more than one.
predetermined—established in advance.
procedure—a set of machine-readable instructions adapted to perform a specific task.
processing—executing machine-readable instructions on an information device.
processor—any one or combination of, hardware, firmware, and/or software that acts upon information by manipulating, analyzing, modifying, converting or transmitting information for use by an executable procedure or an information device, and/or by routing the information to an output device. A processor may use or comprise the capabilities of a controller or microprocessor, for example.
produced—created.
providing—supplying.
random—selected in a substantially unbiased manner within a predetermined range.
receive—to take, get, acquire, and/or have bestowed upon.
referenced—directed to.
rules—predetermined methods applied to data.
schema—information describing a database structure.
selected—a chosen item.
set—a related plurality.
SGML—a programming language adapted to define markup languages for documents.
simulated—created as a representation or model of another thing.
source—a point of origin.
SQL—a standard for creating, formatting, updating, and/or querying a relational database.
store—to place, hold, and/or retain data, typically in a memory.
structure—a manner in which components are organized.
subset—a portion of a plurality.
substituted—put in place of something else.
substantially—to a great extent or degree.
system—a collection of mechanisms, devices, data, and/or instructions, the collection designed to perform one or more specific functions.
tab delimited—separated by characters indicative of a tab.
template—a model of a file having a predetermined format.
template processor—a processor adapted to generate a plurality of executable procedures from a template.
user—a person interfacing with an information device.
user interface—any device and/or mechanism for rendering information to a user and/or requesting information from the user.
value—an assigned or calculated numerical quantity.
XML—a markup language adapted for interchanging information on the World Wide Web.

### DETAILED DESCRIPTION

Certain exemplary embodiments comprise a data generator system and method that comprises generating an executable procedure from a template comprising a structure. The system and method comprises processing the executable procedure to generate a plurality of data items. The system and method comprises automatically outputting the plurality of data items in a desired data format.

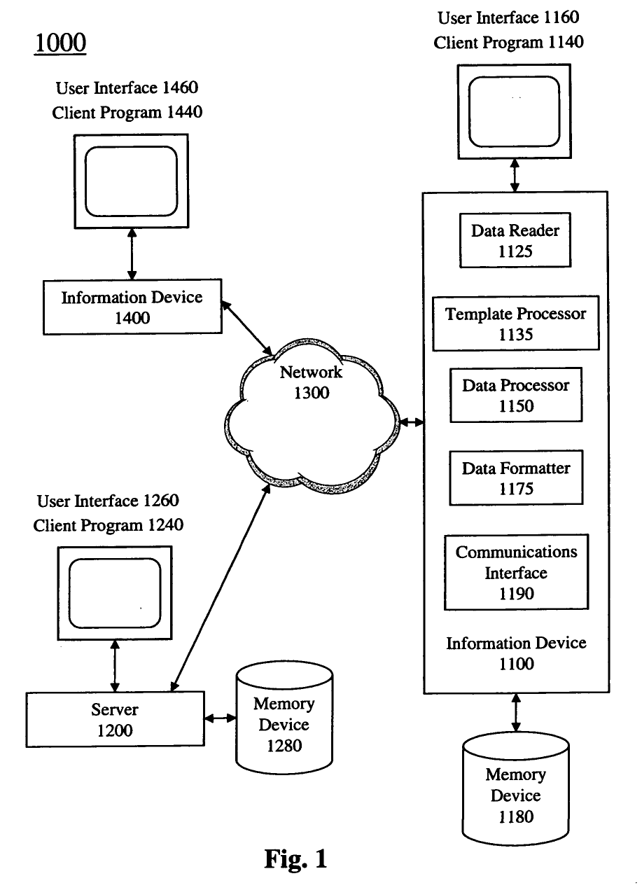

FIG. 1 is a block diagram of a system 1000 for processing application test data. Embodiments of system 1000 are adapted for use by a software user in testing applications, such as a client program 1440 executed on an information device 1400. Applications tested via system 1000 comprise those developed for systems associated with health care, the development, production, marketing, and/or sale of goods and/or services, purchasing for an individual and/or organization, software development, governmental functions; investments, financial management, cost accounting, and/or banking, etc.

System 1000 comprises an information device 1100, which comprises at least one user interface 1160 and/or a client program 1140. Responsive to at least one user selection, client program 1140 creates, modifies, and/or stores application test data. User interface 1160 receives user input and/or renders output to a user, such as information related to creating, modifying, and/or storing application test data, etc.

Hardware and/or software components comprised in information device 1100 are built on a set of swappable components that allow the creation of test data. For example, it is possible for a user to create data-types, which allows values for new data-types such as numeric, binary, or text values, and/or complex data structures, etc., to be generated. It is also possible to create model structures, which allow the user to add an ability to read model structures from metadata associated with a tested application.

For example, it is possible for the user to write an application associated with a SQL database. SQL databases are created and configured using meta-data SQL such as the “Create Table” statement. It is possible for the user to create embodiments that read Create Table statements and generate a model structure based on these statements. Additional data structures are possible, which allow the user to create data in any of a plurality of structures that comprise SQL databases, XML, delimited flat files, HL7, and/or any other structure, etc. Additional data mediums are possible, which allow the user to output data directly to a file, a database, a network stream, and/or any other location that the user desires, etc.

Information device 1100 comprises a data reader 1125 for providing a template to a template processor 1135 in response to a received data file. It is possible for a simple XML parser or any parser that reads a source as hierarchical information to provide the received data file. The received data file comprises information defining a template for application test data. The template comprises schema information for a file and/or database to be created, modified, and/or stored by system 1000. For example, possible schema information comprises a record identifier, number of fields, field moniker, field data type (e.g., integer, floating point number, and/or ASCII character, etc.), field size, and/or restrictions on field content, etc. For example, for a database comprising personal information regarding an individual, schema information might include that a social security number is represented as a nine-digit integer. For example, an exemplary schema restricts content by not allowing a set of zeros as a social security number.

Information device 1100 comprises a template processor 1135 for generating a plurality of hierarchically ordered executable procedures from a template comprising a structure and a plurality of rules. The schema provides the structure. For example, for a social security number, the structure is defined as a nine-digit integer. The plurality of rules is derived from the schema, and comprises rules such as permitted values, permitted ranges, and/or number of digits or characters permitted, etc. Thus, for the social security number example, a possible rule says that a social security number cannot contain letters of the alphabet.

Information device 1100 comprises a data processor 1150 for iteratively processing hierarchically ordered executable procedures to generate a plurality of structured data items. Data processor 1150 generates valid and/or invalid cases of structured data items. Valid and/or invalid cases of structured data items provide the user with a test of performance of application software and exception handling therein. For example, if the user wants to determine how an application would respond to a character of the alphabet in a social security number, an invalid case would test this functionality. The hierarchically ordered executable procedures include a particular procedure for receiving data items from a data source, such as from user interface 1160 and/or memory device 1180. Receiving data items from the data source allows the user to provide certain predetermined data to data processor 1150. Data processor 1150 employs received data items as generated data items that are provided to data formatter 1175. For example, responsive to input from the user, one test field for social security number would be 245678901.

The hierarchically ordered executable procedures mutually interact with each other by exchanging a command initiating data generation. A first procedure of the hierarchically ordered executable procedures determines a value of a data item in response to a value of a data item determined by a second procedure of the hierarchically ordered executable procedures. For example, if a second procedure determines that an address is in Los Angeles, Calif., the first procedure automatically determines the zip code associated with the address.

Data is generated in response to execution of code in an individual hierarchically ordered executable procedure. Data processor 1150 receives data items in response to instructions either from a system or a user and substitutes received data items for data item values produced by at least one hierarchically ordered executable procedure. For example, a zip code of 00000 is supplied, data processor 1150 substitutes that value for a value otherwise created for the data item from a number generation procedure.

Data processor 1150 executes a procedure of the hierarchically ordered executable procedures to determine a value of a data item from a particular subset of values determined by procedure instructions. For example, a random or pseudo-random number generator might be used to determine a value of a social security number in test data produced by data processor 1150. Data processor 1150 executes a procedure of the hierarchically ordered executable procedures referenced from the template. Thereby, test data is provided for the application.

Exemplary structured data items typically comprise one or more invalid cases adapted to test application software intended to detect and/or respond to invalid cases. Structured data items sometimes comprise one or more substantially random values generated within a predetermined range of values by data processor 1150. Structured data items often do not comprise a complete set of possible valid values. For example, even though possible valid social security numbers might range from 000000001 to 999999999, structured data items are not always comprise either of those values.

Information device 1100 comprises a data formatter 1175 for automatically outputting structured data items in a desired data format. Data formatter 1175 is able to output a structured data item in a desired data format comprising at least one of: XML, SGML, HTML, HL7, SQL, ASCII, CSV, tab-delimited, and/or a user selected data format, etc. Providing the structured data item in a desired format allows the user to test application software in a variety of languages and on a variety of platforms.

Information device 1100 is communicatively coupled to a memory device 1180. Memory device 1180 stores information related to user created, modified, and/or stored application test data acted upon via information device 1100.

Information device 1100 comprises a communications interface 1190 adapted to link information device 1100 to a network 1300. Network 1300 communicatively couples information devices such as information device 1100 and a server 1200. Architectures for network 1300 comprise a direct connection, local area network, wide area network such as the public switched telephone network, Internet, extranet, and/or any combination thereof, etc. Types of network 1300 comprise a packet-switched, circuit-switched, connectionless, connection-oriented network, interconnected networks, and/or any combination thereof, etc. Orientations of network 1300 comprise voice, data, and/or any combination thereof, etc. Moreover, transmission media of network 1300 comprise wireline, satellite, wireless, and/or any combination thereof, etc.

Server 1200 is adapted to receive information transmitted from information device 1100 via network 1300. Server 1200 comprises components such as a user interface 1260 and a client program 1240.

Server 1200 is communicatively coupled to memory device 1280. Applications and/or application test data are obtained from and/or provided to server 1200 via network 1300 and are stored on memory device 1280. Memory device 1280 stores application test data in a manner allowing the information to be accessible by other devices, such as information device 1400.

Memory device 1180 and/or memory device 1280 are any devices capable of storing analog or digital information, for example, a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. Memory device 1180 and/or memory device 1280 stores information related to applications and/or application test data. Formats to store information in memory device 1180 and/or memory device 1280 comprise database standards such as XML, Microsoft SQL, Microsoft Access, MySQL, Oracle, FileMaker, Sybase, and/or DB2, etc.

System 1000 comprises information device 1400, which comprises user interface 1460 and/or client program 1440. The user obtains, reviews, enters, accesses, views, completes, and/or revises information on applications, such as client program 1440. The user uses application test data generated by information device 1100 to verify performance of client program 1440. Information related to testing client program 1440 is rendered on user interface 1460.

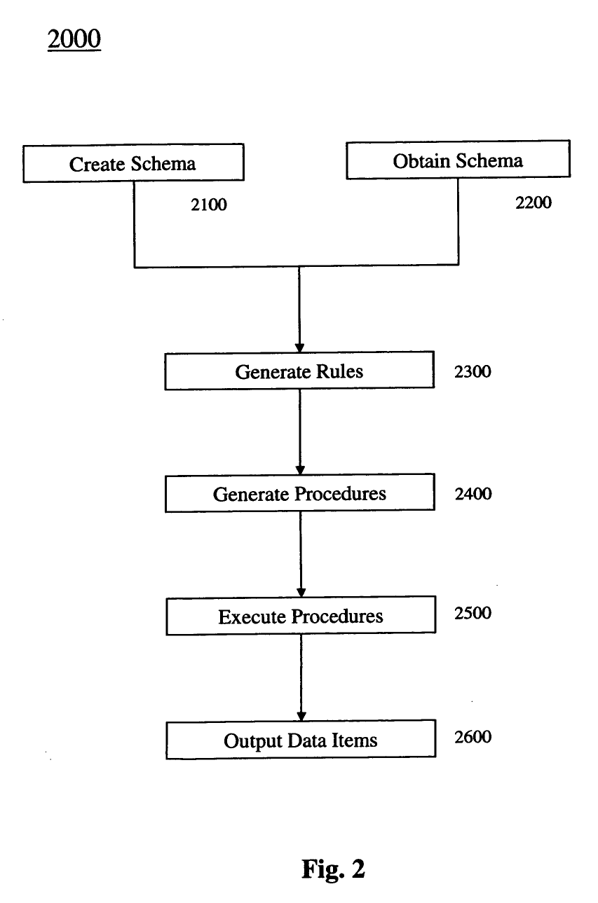

FIG. 2 is a flowchart of a method for processing application test data 2000. At activity 2100, a schema is created. For example, if the schema is associated with a database, the schema comprises information regarding the database operated upon by an application. The schema defines a structure of the database. The schema comprises a plurality of rules related to data types, field sizes, data relationships, keys, key relationships, and/or other linked databases, etc.

At activity 2200, a schema or a template is obtained via examining, scanning, testing, and/or receiving metadata regarding the database. The schema or template provides information usable to create and/or format application test data. The schema or template is provided to a template processor in response to a received data file. The received data file is often provided by a user desiring application test data.

At activity 2300 rules are generated and/or created. The rules are used for generating application test data. Some application test data is generated to comply with rules. Some application test data is generated intentionally not to comply with rules in order for the user to determine whether an application appropriately handles both valid and invalid cases. For example, it is possible for a rule to restrict selections of a first name to a predetermined list of several hundred or several thousand predefined first names. A first rule determines a file or database comprising the names, a second rule determines which of a plurality of first names is selected. Similarly, it is possible for a rule for generating social security numbers to comprise a pseudo-random number generator that provides an apparently random nine-digit number, for example.

At activity 2400 procedures are generated. For example, hierarchically ordered executable procedures are generated from the schema. For example, a relatively high order procedure creates a database comprising a plurality of predetermined fields. A lower order procedure provides definitions and/or restrictions for the type of data in each field (e.g., a character field of 30 characters for surnames). A lower order procedure provides a pseudo-random number generator providing two or three digit integers for a field indicative of an individual's age. Similar procedures are generated until provisions are made to fill data elements requested by the user. The hierarchically ordered executable procedures provide machine-readable instructions for generating application test data.

At activity 2500 procedures, such as individual hierarchically ordered executable procedures, are executed and/or iteratively processed to generate a plurality of structured data items. The generated structured data items can be stored in a database and/or used to test, for example, in the case of health-care related data, application software designed for automating an insurance claim process. It is possible for the structured data items to comprise both valid and invalid cases of data and/or to comprise a random value. Often, the user specifies the number of data items provided by method for processing application test data 2000.

At activity 2600 application test data items are outputted. For example, the plurality of structured data items is automatically output in a desired data format for use by software of interest.

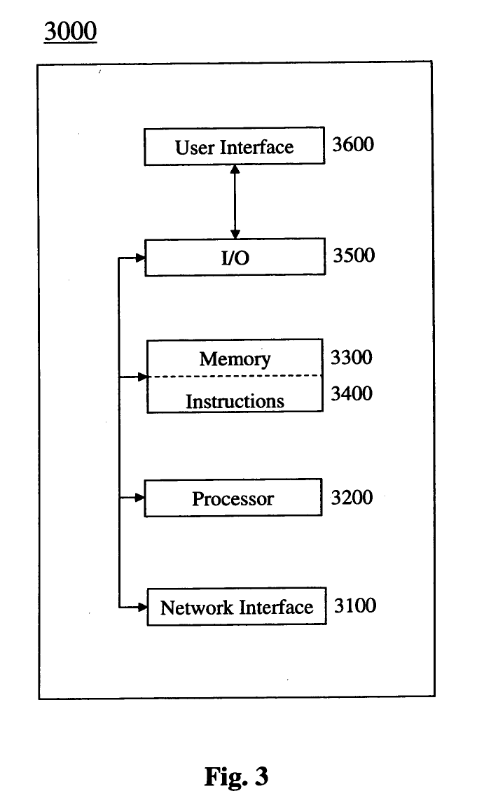

FIG. 3 is a block diagram of an information device 3000, which in certain operative embodiments comprises, for example, server 1200, information device 1100, and information device 1400 of FIG. 1. Information device 3000 comprises any of numerous well-known components, such as for example, one or more network interfaces 3100, one or more processors 3200, one or more memories 3300 containing instructions 3400, one or more input/output (I/O) devices 3500, and/or one or more user interfaces 3600 coupled to I/O device 3500, etc.

Via one or more user interfaces 3600, such as a graphical user interface, a user is able to view a rendering of information related to creating, modifying, and/or storing application test data.

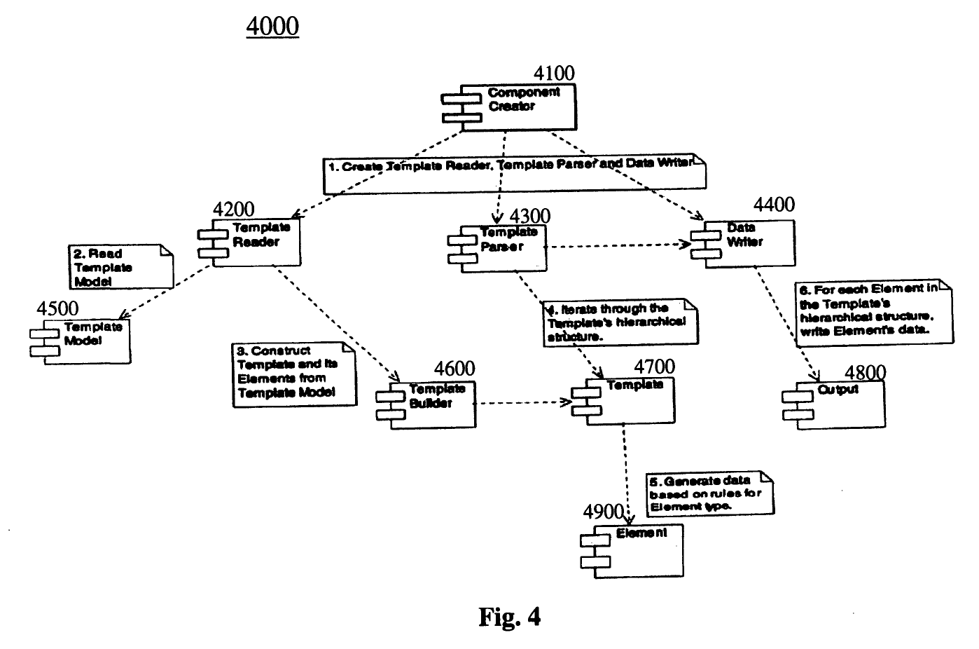

FIG. 4 is an exemplary embodiment of a class diagram 4000 of a Data Generator. The data types, ranges of values and structure of the data are modeled by the Data Generator. The user invokes generation of the data according to the model. It is possible for the data generated to contain a combination of hard-coded and randomly generated values. It is possible for the user to specify that a small amount of data is generated (such as one record), or a large amount of data is generated (such as millions of records for performance testing).

It is possible for the user to extend the functionality of the Data Generator. The Data Generator provides programmable interfaces for adding new ways of generating data, reading template, creating data structures and writing data. For example, it is possible for the user to extend the Data Generator to write to a network socket instead of a text file. A network socket is a special device file that represents a communications connection, such as to another program on another computer over a network.

The Data Generator uses XML as a default modeling language and is extendable to employ any modeling language. The Data Generator configures data types. For example, a social security number might be configured as an integer data type comprising nine digits. The Data Generator outputs data in different formats.

The Data Generator comprises a plurality of modules such as a Component Creator 4100, Template Reader 4200, Template Parser 4300, Data Writer 4400, Template Model 4500, Template Builder 4600, Template 4700, Output 4800, and Element 4900 components.

Component Creator 4100 provides a programmable interface to the Data Generator module, which is responsible for creating the other components. A feature of component creator 4100 is that it allows a client program to specify classes that implement Template Reader 4200 and Data Writer 4400.

The Data Generator accepts as an input one or two data generation templates. Template 4700 specifies the structure of the data to be generated. Template reader 4200 parses this structure and instructs Template Builder 4600 to create Element 4900 components. Template Reader 4200 creates Template Model 4500 after parsing the structure of the data to be generated. The Data Generator allows any template reader class to be used that implements an appropriate programmable interface, such as Template Reader 4200. Template Reader 4200 retrieves the template structure in any way the user chooses, but refers to one or more subroutines of Template Builder 4600.

Template Builder 4600 receives information about the element hierarchy from Template Reader 4200. Template Builder 4600 is an implementation of a SAX document handler (SAX or “Simple API for XML” is a popular API for handling the content of XML documents). While SAX is typically used for the processing of XML documents, SAX is also adapted for use in processing hierarchical information regarding other file and/or database formats. This allows Template Reader 4200 to be a simple XML parser or any parser that reads a source as hierarchical information.

Template Builder 4600 receives the element hierarchy from Template Reader 4200 and creates Element 4900 components. Element 4900 components are created based on attribute information.

Template 4700 is a hierarchy of Element components. It is created by Template Builder 4600 and is treated as an Element 4900. Template 4700 is considered the root node of the Element 4900 hierarchy.

Element 4900 components are implementations of an Element interface. Each Element 4900 represents a node in the hierarchy created by Template Builder 4600. Each Element 4900 component is an instance of a class that conforms to the Element interface. The Element interface specifies that Element 4900 components have methods to retrieve a value, retrieve child Element 4900 nodes, a number of times to repeat the element, and retrieve the attributes used to create Element 4900.

By traversing the Element hierarchy, beginning with the Template 4700 node, and requesting the value from each Element 4900 component, the values are considered in a structure matching the structure of the Element hierarchy. Element 4900 components use the attributes they were created with and are often implemented to randomize, in some way, the data they provide.

In addition to being able to define any type of Element component, Elements 4900 also extend other Elements 4900 by providing an attribute to a particular Element 4900 named “type.” The value of the type attribute refers to the value of the name attribute of another Element 4900 defined in the Element hierarchy. Attributes of a first Element 4900 are used in the creation of a second Element 4900. Elements 4900 are extended from already extended Elements 4900 in this way as well.

Template Parser 4300 iterates over the Element components, beginning with the Template 4700 node. Its first step is to notify Data Writer 4400 that it has begun processing. Each time Element 4900 is encountered, Template Parser 4300 notifies Data Writer 4400 component that an Element 4900 was encountered. Template Parser 4300 then requests Element 4900 component's value and relays that to Data Writer 4400. Template Parser 4300 requests a list of children from each Element 4900 component. For each of the children, Template Parser 4300 requests from the child how many times it should be repeated. Template Parser 4300 processes the child Element 4900 that many times. Template Parser 4300 also notifies the Data Writer 4400 when an Element 4900 and child Elements 4900 associated with Element 4900 has been processed. Finally, when every Element 4900 in the hierarchy has been processed, Template Parser 4300 notifies Data Writer 4400 that processing is complete.

Data Writer 4400 is another implementation of a SAX document handler. Any implementation is allowed. It receives notifications from Template Parser 4400 for the start and end of processing, the start and end of each element and the value produced by each element. Data Writer 4400 outputs data in any predetermined or user selected format to any medium, which provides flexibility allowing generated data to follow any output format without changing how the template defining the data is structured.

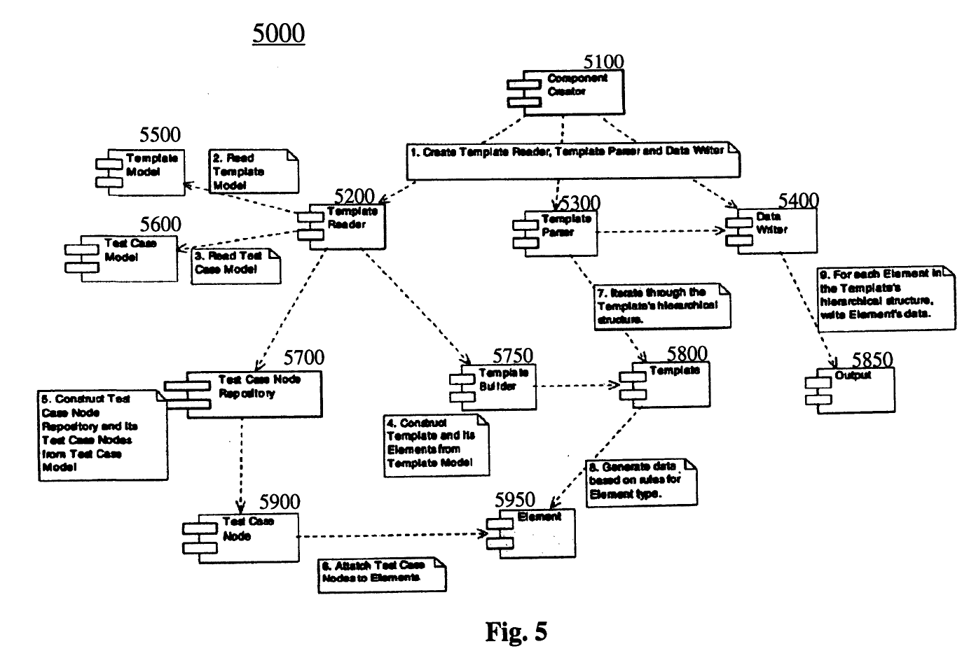

FIG. 5 is an exemplary embodiment of a class diagram 5000 of a Data Generator. The Data Generator comprises a plurality of modules such as a Component Creator 5100, Template Reader 5200, Template Parser 5300, Data Writer 5400, Template Model 5500, Test Case Model 5600, Test Case Node Repository 5700, Template Builder 5750, Template 5800, Output 5850, Test Case Node 5900, and Element 5950 components.

Component Creator 5100 provides a programmable interface to the Data Generator module, which is responsible for creating the other components. A feature of component creator 5100 is that it allows creation of Template Reader 5200, Template Parser 5300, and/or Data Writer 5400.

The Data Generator accepts as an input at least one data generation template. Template Model 5500 is created from Template reader 5200 reading the template model. Responsive to user desires and/or restrictions for test data, Template Reader 5200 uses Template Model 5500 to create Test Case Model 5600. For example, if the user is interested in program behavior when a social security number begins only with the digit “0”, Test Case Model 5600 might restrict data generation to a subset of cases comprising such social security numbers. This approach allows the user to constrain data generation to a smaller number of test data sets.

It is possible for the user to apply a test case configuration to Test Case Model 5600, which allows the user to specify the value of specific elements within the data. The rest of the data is generated according to Template Model 5500. Once Test Case Model 5600 is built, it is possible to create any number of tests that focus on the actual testing scenarios.

For example, it is possible for the user to extend a test data generator application to have a data type that generates random and/or pseudo-random telephone numbers. If the user desired that in some data records telephone numbers are to comprise certain area codes, the Data Generator allows an extended data type to read parameters pertinent to the element of data being generated. The Data Generator provides a test case configuration feature that allows test cases to be specified allowing the user to focus just on the data being tested and removing the burden of sifting through the entire model structure to configure a test case.

Template Reader 5200 provides information to create Test Case Node Repository 5700 from Test Case Model 5600. Test Case Node Repository 5700 creates Test Case Node 5900. For the previously discussed social security number example, Test Case Node 5900 might comprise the field filled with a predetermined nine-digit number.

Test Case Node 5900 is a special implementation of Element component 5950. Test Case nodes 5900 are specified from a separate data source than the template hierarchy. They allow any Element 5950 specified by the Template hierarchy to be overridden. Elements 5950 in the template hierarchy are uniquely identified by their location in the template hierarchy. Test Case Node 5900 specifies a location of Element 5950 in the hierarchy and a constant value to provide instead of the value that would have otherwise been provided by the Element 5950 component. This allows a separate Test Case hierarchy to be constructed to override specific portions of the Element hierarchy specified by the template. This provides the ability to create structured data that is mostly generated from the Element hierarchy, but has some values that are hard-coded. This is useful in creating test cases where small bits of the data are important, but overall most of the data is generated simply to meet the correct structure.

Test Case Node Repository 5700 stores the set of Test Case Nodes 5900. It is responsible for matching the Test Case Node 5900 to the corresponding Element 5950 component in the Element hierarchy. When a match is made, it replaces the Element 5950 component with the Test Case Node 5900. This allows the rest of the program to operate without being aware of the Test Case.

Template Reader 5200 constructs Template Builder 5750 and its elements from Template Model 5500. Template Builder 5750 receives information about the element hierarchy from Template Reader 5200. Template Builder 5750 provides Template Parser 5300 with Template Model 5500. Template Parser 5300 iterates through the structure of Template Model 5500 to generate rules for each Element type comprised in Template Model 5500.

Each Element 5950 is created from Template 5800. Components of each Element 5950 components are created based on attribute information. Template 5800 provides a hierarchy of Element components.

Element 5950 components are implementations of an Element interface. Each Element 5950 represents a node in the hierarchy created by Template Builder 5750. Each Element 5950 component is an instance of a class that conforms to the Element interface.

Template Parser 5300 notifies Data Writer 5400 that it has begun processing. Each time an Element 5950 is encountered, Template Parser 5300 notifies Data Writer 5400 component that an Element 5950 was encountered. Template Parser 5300 then requests a value for Element 5950 and relays the value to Data Writer 5400. Template Parser 5300 requests a list of children from each Element 5950 component. For each of the children, Template Parser 5300 requests from the child how many times it should be repeated. Template Parser 5300 processes the child Element 5950 that many times. Template Parser 5300 also notifies the Data Writer 5400 regarding processing of Element 5950 and each child thereof. Finally, when every Element 5950 in the hierarchy has been processed, Template Parser 5300 notifies Data Writer 5400 that processing is complete.

The Data Generator improves the ability of the user ability to generate data for testing. By allowing Data Writer 5400 to be programmatically overridden, the Data Generator achieves a goal of creating data that meets any output structure. Additionally, by providing a method to modify specific values within that structure using Test Case Nodes 5900, the Data Generator is used as a tool to test specific application scenarios.

In another embodiment Data Writer 5400 component is replaced with a non-swappable component to restrict output to one format of output data. A separate application reads this data format and translates it into a desired data format.

The Data Generator enables the construction of software and/or hardware utility that is used to generate test data for input into other software applications. The test data is constructed in such a way that various levels of testing, including unit, integration and other tests are performed. Additionally, it allows for bulk amounts of data to be generated following a user-supplied pattern. The bulk data is used for performance, scalability, load testing, and/or fault-tolerance testing, etc.

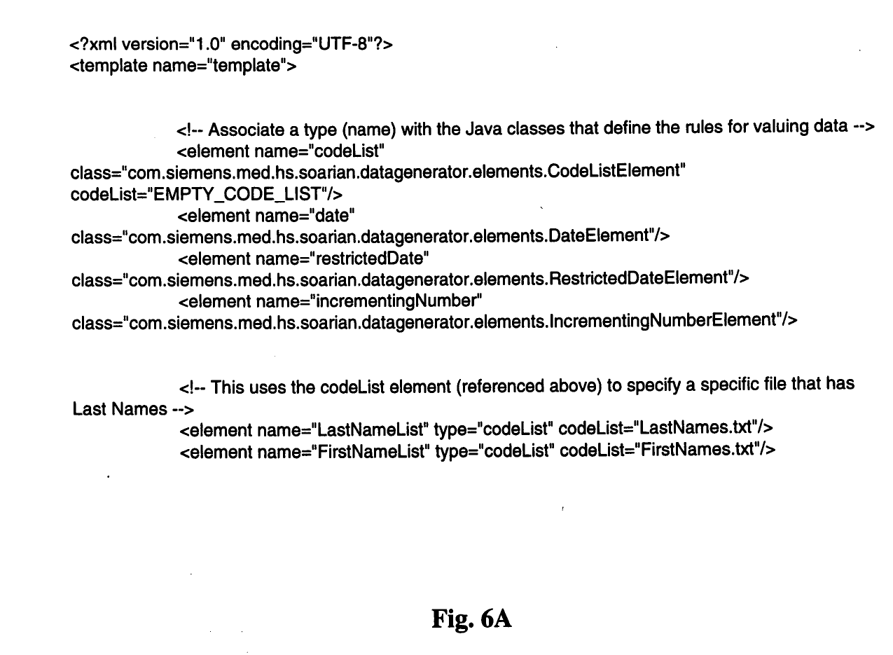

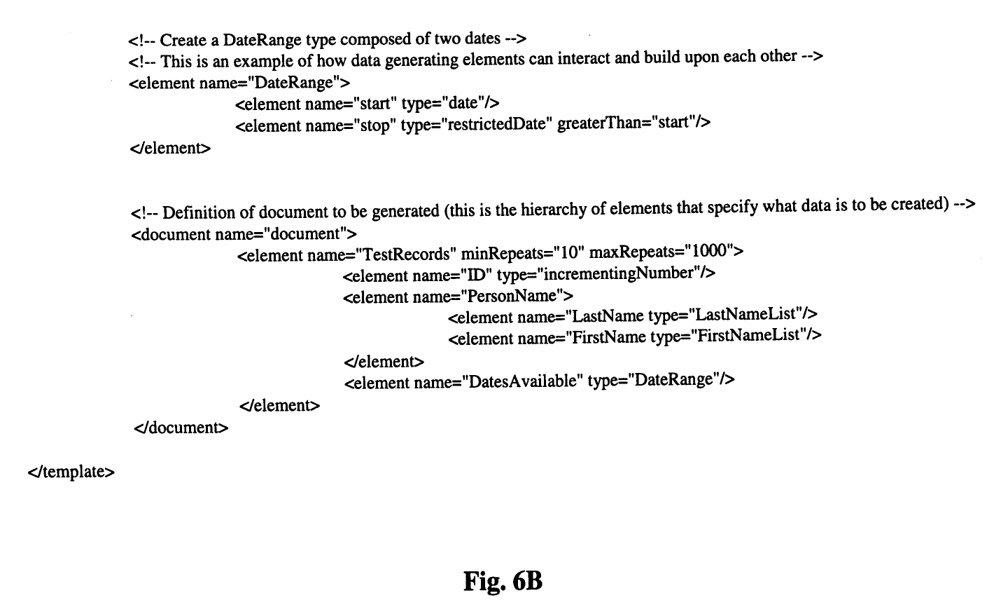

An illustrative example of a schema for activity 2200 is shown in FIG. 6A and FIG. 6B. FIG. 6A is an exemplary embodiment of a first section of a template, and FIG. 6B represents a second section of the template. It is possible to use the template illustrated in FIG. 6A and FIG. 6B to create, for example, between 10 and 1000 records, where each record contains an ID, a person's name, and a date range. The ID is an incrementing number. The name comprises a first name and a last name (possibly selectable from a file comprising names). The date range comprises a start date and a stop date. In some embodiments, a template comprises several dozen to possibly thousands of <element> tags. Certain templates model HL7 data and comprise over 1000 interacting elements. In creating data to test applications, some embodiments create tens of millions of records.

For example, rules can be derived and/or determined from the exemplary template illustrated in FIG. 6A and FIG. 6B. Exemplary rules for this exemplary template comprise:
1. restricting the value of an element by the generated value of another element (e.g., the stop date must be after the start date);
2. specifying the number of times an element of data is created (e.g., creating between 10 and 1000 test records—the number of records can be specified at any level—for example, it is possible to specify a date range to comprise 3 start dates and between 5 and 10 stop dates); and/or
3. identifying a reusable hierarchy of elements (for example, a date range comprises two date elements).

While the schema or template indicates which rules to use, the user is responsible for creating the code that implements the rules. In another embodiment the system automatically creates the code. For example, in the exemplary template illustrated in FIG. 6A and FIG. 6B, the rules are implemented in Java code—the template references the Java code through the class attribute of the first four elements.

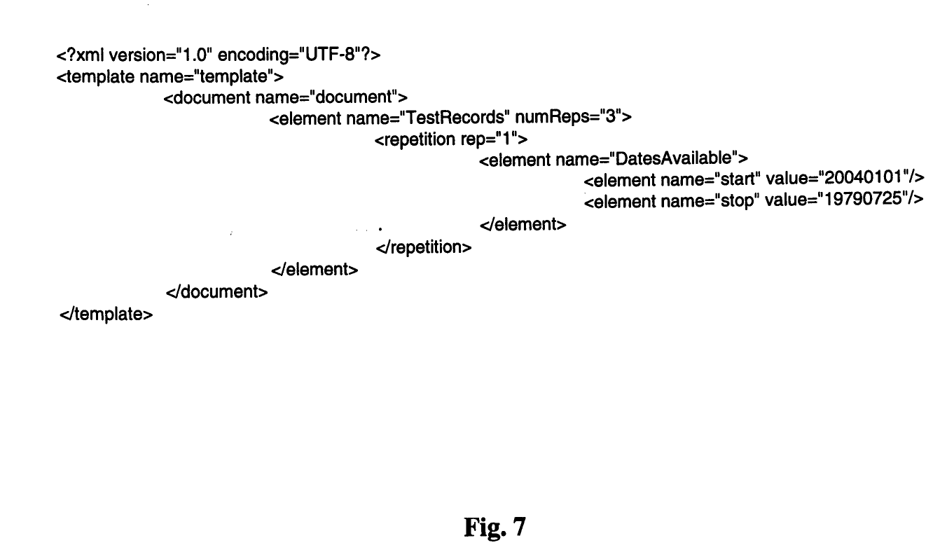

An exemplary embodiment of code for an exemplary test case model is illustrated in FIG. 7. The code illustrated in FIG. 7 is usable with the template illustrated in FIG. 6A and FIG. 6B. A test case model is sometimes used to put specific values and restrictions in the template. It is possible to use a test case model with a complex element structure. Some test cases focus on a few simple values. The test case model illustrated in FIG. 7 uses the template illustrated in FIG. 6A and FIG. 6B but restricts it by creating exactly 3 records and makes sure that start date of the first record is greater than the stop date.

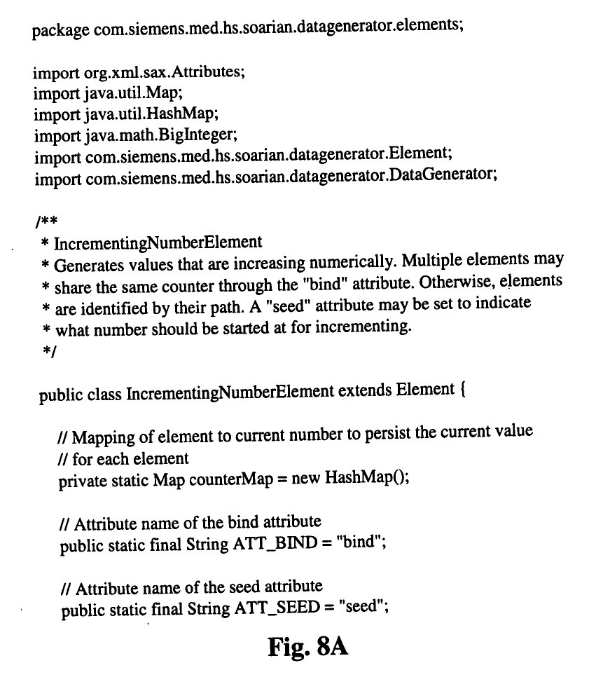

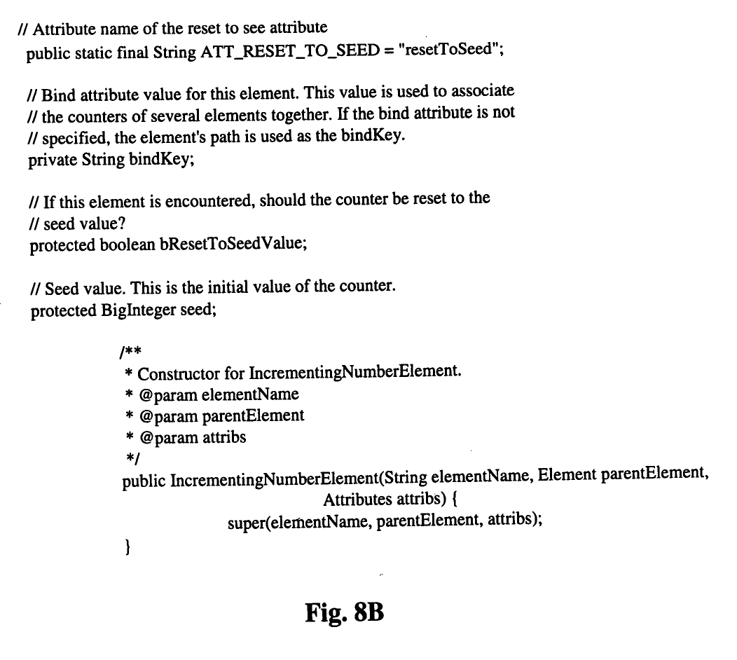

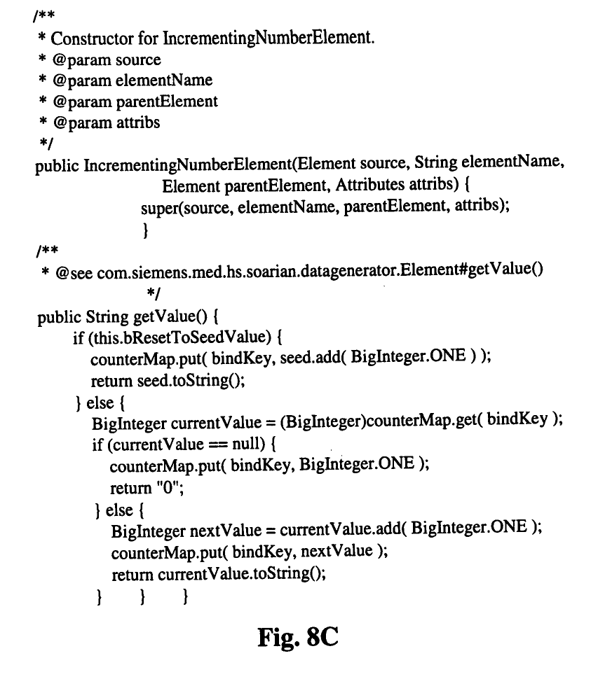

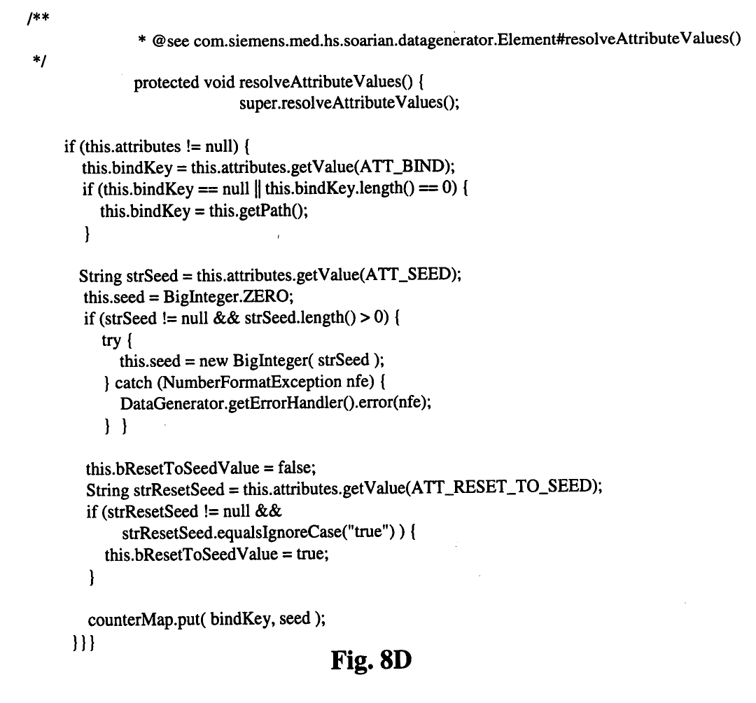

Exemplary code implementing an “incrementing number” element implementation is illustrated in FIG. 8A, FIG. 8B, FIG. 8C, and FIG. 8D. The exemplary code is written in Java. It is possible, however, to create code in any language to produce data for applications to be tested.

Still other embodiments are readily apparent to those skilled in this art from reading the above-recited detailed description and drawings.

What is claimed is:

1. A data generator system, comprising:
a template processor for generating a plurality of hierarchically ordered executable procedures from a template comprising a structure and a plurality of rules;
a data processor for iteratively processing said hierarchically ordered executable procedures to generate a plurality of structured data items, wherein the plurality of structured data items comprise simulated medical data, at least one invalid case and at least one random value; and
a data formatter for automatically outputting said plurality of structured data items in a desired data format.

2. A system according to claim 1, further comprising:
a data reader for providing said template to said template processor in response to a received data file.

3. A system according to claim 1, wherein:
data is generated in response to execution of code in an individual hierarchically ordered executable procedure.

4. A system according to claim 1, wherein:
said plurality of hierarchically ordered executable procedures mutually interact by exchanging a command initiating data generation.

5. A system according to claim 1, wherein:
said data formatter outputs a structured data item in a desired data format comprising at least one of: XML, SGML, HTML, HL7, SQL, ASCII, CSV, tab-delimited, and a user selected desired data format.

6. A system according to claim 1, wherein:
said plurality of hierarchically ordered executable procedures includes a particular procedure for receiving a data item from a data source; and
said data processor employs said received data item as a generated data item.

7. A system according to claim 6, wherein:
said received data item is received in response to user command and is substituted for a data item value produced by said particular procedure.

8. A system according to claim 1, wherein:
a first procedure of said hierarchically ordered executable procedures determines a value of a data item in response to a value of a data item determined by a second procedure of said hierarchically ordered executable procedures.

9. A system according to claim 1, wherein:
a procedure of said hierarchically ordered executable procedures determines a value of a data item from a particular subset of values determined by procedure instructions.

10. A system according to claim 1, wherein:
a first procedure of said hierarchically ordered executable procedures is referenced from said template.

11. A method, comprising a plurality of activities comprising:
obtaining a schema defining a structure and a plurality of rules;
generating a plurality of hierarchically ordered executable procedures from the schema;
iteratively processing said hierarchically ordered executable procedures to generate a plurality of structured data items, wherein the plurality of structured data items comprise simulated medical data, wherein the plurality of structured data items comprise at least one invalid case, wherein the plurality of structured data items comprise at least one random value; and
automatically outputting said plurality of structured data items in a desired data format.

12. A method according to claim 11, further comprising:
creating the schema.

13. A method according to claim 11, further comprising:
creating at least one of the plurality of rules.

14. A method according to claim 11, further comprising:
providing said schema to a template processor in response to a received data file.

15. A method according to claim 11, further comprising:
executing an individual hierarchically ordered executable procedure.

16. A data generator system, comprising:
a template processor for generating a plurality of hierarchically ordered executable procedures from a template comprising a structure and a plurality of rules;
a data processor for iteratively processing said hierarchically ordered executable procedures to generate a plurality of structured data items comprising simulated medical data, at least one invalid case and at least one random value creatable from said processing of said hierarchically ordered executable procedures; and
a data formatter for automatically outputting said plurality of structured data items in a desired data format.
